(19) United States
(12) Patent Application Publication
(10) Pub. No.: US 2001/0023405 A1
(43) Pub. Date: Sep. 20, 2001

(54) Method, apparatus, and computer program for generating a feeling in consideration of agent's self-confident degree

(75) Inventor: Izumi Nagisa, Tokyo (JP)

Correspondence Address: David A. Blumenthal, FOLEY & LARDNER, Washington Harbour, 3000 K Street, N. W., Suite 500, Washington, DC, 20007-5109, US

(73) Assignee: NEC CORPORATION

(21) Appl. No.: 09/799,022

(22) Filed: Mar. 6, 2001

(30) Foreign Application Priority Data
Mar. 7, 2000 (JP) 2000-61469

(51) Int. Cl. G06F 17/60

(52) U.S. Cl. 705/10

(57) ABSTRACT

In a feeling generation apparatus for accompanying a reaction and an information proposal of a computer with an agent's feeling, a proposal item retrieving part assigns, with reference to a user's taste model, a taste level to said proposal item. With reference to an agent's self-confident degree model describing correspondences between taste's levels for the proposal item and agent's self-confident degrees for proposal, a self-confident degree calculating part calculates an agent's self-confident degree for said proposal item. With reference to the agent's feeling model describing correspondences among the agent's self-confident degrees, user's responses, and agent's feelings, a feeling generating part determines the agent's feeling. In accordance with the determined agent feeling, an output data generating part generates a proposal sentence for proposing the proposal item and data for an operation and an expression of a computer graphics (CG) character.

### BACKGROUND OF THE INVENTION

This invention relates to a feeling generator for use in an information retrieval apparatus or an information presentation apparatus to make reaction or information presentation of a computer accompany feelings in a conversation between a user and the computer.

Various techniques to make a computer accompany feelings in a conversation system are already proposed. By way of example, Japanese Unexamined Patent Publication Tokkai No. Hei 6-12,401 or JP-A 6-12401 (Title of Invention: “EMOTION SIMULATING DEVICE”) proposes an interactive information input/output system in which an agent has eight fundamental emotions or feelings and a pseudo-feeling is incorporated in the agent so as to change the basis feelings of the agent in accordance with a user's utterance, an accomplishment condition of a task, or the like.

The term “agents” is used to strictly mean software executing works for a person and there is an interface agent as one of the agents. The interface agent is an interface where a system actively works upon a user and includes personified interface technique which obviously presents an easy conversation between the system and the user and necessary information at an exquisite timing. A personified agent, which belongs to a category of the interface agent, presents the user with a system state (for example, understanding for a user's question) by adding personified behavior such expression and operation of an animation character to the system. That is, the “personified agent” is one where an expression or a face is added to the interface agent.

More specifically, disclosed in JP-A 6-12401, is the emotion simulating device which comprises a storage means for holding a fundamental element emotion intensity in order to make the agent possess a simulated emotion state. In addition, the emotion simulating device comprises a means for changing the possessed fundamental emotions of the agent on the basis of an event which occurs in an external environment. Furthermore, the emotion simulating device comprises a means for preliminarily determining interactions between the fundamental element emotions within the emotion state and for autonomously changing the emotion state by causing the above-mentioned interactions to occur every a predetermined time interval and by causing increment and decrement to occur between each fundamental element emotion intensity. Furthermore, the emotion simulating device comprises a means for exponentially attenuating each Fundamental element emotion intensity with the passage of time and for putting each fundamental element emotion intensity into a steady state or putting the emotion state into a neutral state as a whole after a time sufficiently elapses so that any event does not occur in the external environment.

In addition, Japanese Unexamined Patent Publication Tokkai No. Hei 9-81,632 or JP-A 9-81632 (Title of Invention: “INFORMATION PUBLICATION DEVICE”) proposes a device for estimating a feeling of a user by using feeling words included in a text or sound and frequency of conversations and for determining a response plan of the conversations, that is, a response sentence or response strategy in accordance with kinds of the feeling of the user.

More specifically, disclosed in JP-A 9-81632, is the information publication device which is a device for inputting the data of a plurality of forms including a text, sound, a picture and a pointing position, for extracting the intention and feeling information of the user from the inputted data, for preparing a response plan, and for generating a response of the user. This information publication device comprises a user feeling recognition part for recognizing the feeling state of the user from an internal state of a response plan preparation part, the intention and feeling information of the user and the transition on a time base of interaction condition information including the kind of the prepared response plan. The response plan preparation part selects or changes a response strategy corresponding to the recognized result of the user feeling recognition part and prepares the response plan matched with the response strategy.

Furthermore, Japanese Unexamined Patent Publication Tokkai No. Hei 9-153,145 or JP-A 9-153145 (Title of Invention: “AGENT DISPLAY”) discloses a user interface executing processing suited to a user' purpose and requirement and the skillfulness level. Disclosed in JP-A 9-153145, is the agent display which comprises an agent object storage area for storing attribute data of an agent, a message storage area for storing a message of the agent, and a frame picture storage area for storing a frame picture of the agent. By a clothes image setting means for superscribing a clothes image with a display image of the agent, a field of retrieval object is clearly represented.

In addition, although there is no personified agent, Japanese Unexamined Patent Publication Tokkai No. Hei 10-162,027 or JP-A 10-162027 (Title of Invention: “METHOD AND DEVICE FOR INFORMTAION RETRIEVAL”) discloses an information retrieval method and device which is capable of easily retrieving, from a huge number of information elements, a particular information element which a user desires. In the information retrieval method and device disclosed in JP-A 10-162027, it is possible to easily retrieve the particular information element desired by the user, from a huge number of programs by determining the priority order of information according to a basic choice taste peculiar to a user.

Furthermore, Japanese Unexamined Patent Publication Tokkai No. Hei 11-126,017 or JP-A 11-126017 (Title of Invention: “STORAGE MEDIUM, ROBOT, INFORMATION PROCESSING DEVICE AND ELECTRONIC PET SYSTEM”) discloses a technical idea which is capable of realizing a realistic electronic pet by employing various devices. In JP-A 11-126017, an IC card stores internal condition parameters including the feeling of an electronic pet. The internal condition parameters indicate internal conditions of the electronic pet. If electronic pet starts an action based on the internal condition parameters, the IC card stores the updated items in accordance with the action. The IC card is freely attachable and detachable to the device which functions as the body of the electronic pet. A virtual pet device conducts the processes to display the electronic pet which functions as the body of the electronic pet. The virtual pet device has a slot through which the IC card is freely attachable and detachable.

In addition, Japanese Unexamined Patent Publication Tokkai No. Hei 11-265,239 or JP-A 11-265239(Title of Invention: “FEELING GENERATOR AND FEELING GENERATION METHOD”) proposes a feeling generator which is capable of recalling a prescribed feeling under a new condition satisfying a learned incidental condition by synthesizing recall feeling information and reaction feeling information and generating self feeling information original to a device. In the feeling generator disclosed in the JP-A 11-265239, a reaction feeling generation part generates and outputs the feeling original to the device changed directly reacting with a condition information string for a specified period by a condition description part. A feeling storage generation part generates condition/feeling pair information for which the reaction feeling information by the reaction feeling generation part and a condition string within the specified period by the condition description part are made to correspond to each other and delivers it to a feeling storage description part. A recall information generation part reads the condition string within the specified period from the condition description part, retrieves feeling information corresponding to the condition information string from the feeling storage description part and outputs it as the recall feeling information. A self feeling description part holds the feeling information obtained by synthesizing the reaction feeling information by the reaction feeling generation part and the recall feeling information by the recall feeling generation part as present self feeling information.

There are problems as follows in the above-mentioned Publications.

There is, as a first problem, that a conversation can not be realized with feelings such as self-confidence for recommendation or enthusiasm. Such feelings occur in an information retrieval and presentation device for information presented by a computer in accordance with agreement with a retrieval condition or recommendation ranking.

For example, it is impossible for JP-A 6-12401 to accompany propriety of a result or a degree of recommendation with feelings. This is because JP-A 6-12401 determines the feeling of the agent in accordance with an accomplishment condition of a task or utterance of a user so as to increase, in the task such as a schedule adjustment, a happy feeling of the agent when the task is completed and so as to increase an anger feeling of the agent when the agent does not obtain a speech input from the user although the agent repeats an input request. More specifically, in a case of the task of the schedule adjustment, it is possible for JP-A 6-12401 to accompany a message on completion of the schedule adjustment or a message of the input request with the feelings. However, in a case where there are a plurality of replies or answers as a result of the task of the computer such as a case of retrieving and presenting a proposed schedule for meeting, it impossible for JP-A 6-12401 to accompany the respective answers with the feeling where there is agent's self-confidence for the recommendation along any demand of the user.

There is, as a second problem, a problem such that a response sentence for the feeling has a low flexibility. This is because the response sentence must be determined each developed application although the feeling in the computer side is determined in response to the utterance of the user, the accomplishment condition of the task, or frequency of the conversation and the response sentence for the user is prepared in accordance with the feeling.

For instance, for a response plan so as to order a request, JP-A 9-81632 generates the response sentence of “What do you want with me?” if the feeling is expectation and generates the response sentence of “You may: (1) refer to a schedule of Yamamoto, (2) leave a message for Yamamoto, or (3) connect this line directly to Yamamoto. Please select.” if the feeling represents uneasiness. However, such as a peculiar generation method of the response sentence is disadvantageous in that it is impossible to use the response sentence corresponding to the feeling as it is when other applications are developed and it is therefore necessary to regenerate a new response sentence.

However, such as a peculiar generation method of the response sentence is disadvantageous in that it is impossible to use the response sentence corresponding to the feeling as it is when other applications are developed and it is therefore necessary to regenerate a new response sentence.

### SUMMARY OF THE INVENTION

It is therefore an object of this invention to provide a feeling generation apparatus which is capable of having a conversation with a feeling such as agent's self-confidence for recommendation or enthusiasm for information such as a retrieved result presented by a computer.

It is another object of this invention to provide a feeling generation apparatus of the type described, which is capable of generating, as a response sentence with the feeling from the computer, a general-purpose response sentence usable in various interactive systems with no response sentence peculiar to one interactive system.

Other objects of this invention will become clear as the description proceeds.

On proposing an item that matches with an input condition of a user, a feeling generation apparatus according to a first aspect of this invention refers a user's taste or ranking data, calculates an attribute called an agent's self-confident degree for proposal, and generates a feeling in accordance with the self-confident degree.

More specifically, according to the first aspect of this invention, the feeling generation apparatus accompanies a reaction and an information proposal of a computer with an agent's feeling. The feeling generation apparatus comprises a user's taste model memory for storing a user's taste model describing user's tastes for a user. A proposal item retrieving part retrieves a proposal item matched with the input condition of the user. With reference to the user's taste model, the proposal item retrieving part assigns a taste level to the proposal item. A self-confident degree model memory stores an agent's self-confident degree model describing the correspondences between taste's levels for the proposal item and self-confident degrees for proposal. With reference to the agent's self-confident degree model, a self-confident degree calculating part determines an agent's self-confident degree for the proposal item. An agent's feeling model memory stores an agent's feeling model describing correspondences between the self-confident degrees and agent's feelings. With reference to the agent's feeling model, a feeling generating part determines the agent's feeling for the determined agent's self-confident degree. In accordance with the determined agent feeling, an output data generating part generates a proposal sentence for proposing the proposal item and data for an operation and an expression of a computer graphics (CG) character.

In addition, according to the first aspect of this invention, the feeling generation apparatus accompanies a reaction and an information proposal of a computer with an agent's feeling. The feeling generation apparatus comprises a ranking data memory for storing popular ranking data. A proposal item retrieving part retrieves a proposal item matched with the input condition of the user. With reference to the popular ranking data, the proposal item retrieving part assigns a popular ranking to the proposal item. A self-confident degree model memory stores an agent's self-confident degree model describing correspondences between popular ranks for the proposal item and agent's self-confident degrees for proposal. With reference to the agent's self-confident degree model, a self-confident degree calculating part determines an agent's self-confident degree for said proposal item. An agent's feeling model memory stores an agent's feeling model describing the correspondences between the agent's self-confident degrees and agent's feelings. With reference to the agent's feeling model, a feeling generating part determines the agent's feeling for the determined agent's self-confident degree. In accordance with the determined agent's feeling, an output data generating part generates a proposal sentence for proposing the proposal item and data for an operation and an expression of a computer graphics (CG) character.

According to a second aspect of this invention, a feeling generation apparatus accompanies a reaction and an information proposal of a computer with an agent's feeling. The feeling generation apparatus comprises a proposal item retrieving part for retrieving a proposal item matched with an input condition of a user to produce the proposal item. A self-confident degree model memory stores an agent's self-confident degree model describing correspondences between a proposal count for the proposal item and agent's self-confident degrees for proposal. With reference to the agent's self-confident degree model, a self-confident degree calculating part determines an agent's self-confident degree in accordance with the proposal count for the proposal item sent from the proposal item retrieving part. An agent's feeling model memory stores an agent's feeling model describing the correspondences between the agent's self-confident degrees and agent's feelings. With reference to the agent's feeling model, a feeling generating part determines the agent's feeling for the determined agent's self-confident degree, In accordance with the determined agent's feeling, an output data generating part generates a proposal sentence for proposing the proposal item and data for an operation and an expression of a computer graphics (CG) character.

In the feeling generation apparatus according to the second aspect of this invention, the self-confident degree model memory may store the agent's self-confident degree model describing the correspondences between the proposal count for the proposal item and the agent's self-confident degrees which differ in accordance with an agent's character. The self-confident degree calculating part may calculate the agent's self-confident decree corresponding to the proposal count with adding the agent's character.

According to a third aspect of this invention, a feeling generation apparatus accompanies a reaction and an information proposal of a computer with an agent's feeling. The feeling generation apparatus comprises a user's taste model memory for storing a user's taste model describing user's tastes for a user. A proposal item retrieving part retrieves a proposal item matched with an input condition of the user. With reference to the user's taste model, the proposal item retrieving part assigns a taste level to the proposal item. A self-confident degree model memory stores an agent's self-confident degree model describing correspondences between taste's levels for the proposal item and agent's self-confident degrees for proposal. With reference to the agent's self-confident degree model, a self-confident degree calculating part determines an agent's self-confident degree for said proposal item. An agent's feeling model memory stores an agent's feeling model describing correspondences among the agent's self-confident degrees, user's responses, and agent's feelings. With reference to the agent's feeling model, a feeling generating part determines the agent's feeling on the basis of two attributes of the determined agent's self-confident degree and a user's response inputted from an input part. In accordance with the determined agent feeling, an output data generating part generates a proposal sentence for proposing the proposal item and data for an operation and an expression of a computer graphics (CG) character.

In the feeling generation apparatus according to the third aspect of this invention, the agent's feeling model memory may store the agent's feeling model describing a model where different feelings are selected for each agent's character in the agent's feeling determined by the determined agent's self-confident degree and the user's response. The feeling generating part may generate the agent's feeling which differs from each agent's character.

### BRIEF DESCRIPTION OF THE DRAWING

FIG. 1 is a block diagram of a feeling generation apparatus according to a first embodiment of this invention;

FIG. 2 is a flow chart for user in describing operation of the feeling generation apparatus illustrated in FIG. 1;

FIG. 3 shows an example of an agent's self-confident degree model stored in a self-confident degree model memory for use in the feeling generation apparatus illustrated in FIG. 1;

FIG. 4 shows an example of an agent's feeling model stored in an agent's feeling model memory for use in the feeling generation apparatus illustrated in FIG. 1;

FIG. 5 shows another example of an agent's feeling model stored in an agent's feeling model memory for use in the feeling generation apparatus illustrated in FIG. 1;

FIGS. 6A and 6B show still another examples of agent's feeling models stored in an agent's feeling model memory for use in the feeling generation apparatus illustrated in FIG. 1;

FIG. 7 is a block diagram of a feeling generation apparatus according to a second embodiment of this invention;

FIG. 8 shows an example of an agent's self-confident degree model stored in a self-confident degree model memory for use in the feeling generation apparatus illustrated in FIG. 7;

FIG. 9 is a block diagram of a feeling generation apparatus according to a third embodiment of this invention;

FIG. 10 shows an example of an agent's self-confident degree model stored in a self-confident degree model memory for use in the feeling generation apparatus illustrated in FIG. 9;

FIG. 11 shows an example of an agent's feeling model stored in an agent's feeling model memory for use in the feeling generation apparatus illustrated in FIG. 9;

FIGS. 12A and 12B show another examples of agent's self-confident degree models stored in a self-confident degree model memory for use in the feeling generation apparatus illustrated in FIG. 9;

FIG. 13 is a block diagram of a feeling generation apparatus according to a fourth embodiment of this invention;

FIGS. 14A and 14B collectively show a flow chart for use in describing operation of the feeling generation apparatus illustrated in FIG. 13;

FIG. 15 shows an example of an agent's feeling model stored in an agent's feeling model memory for use in the feeling generation apparatus illustrated in FIG. 13;

FIG. 16 is a view showing an example of conversation between an agent and a user in the feeling generation apparatus illustrated in FIG. 13; and

FIGS. 17A and 17B show another examples of agent's feeling models stored in an agent's feeling model memory for use in the feeling generation apparatus illustrated in FIG. 13.

### DESCRIPTION OF THE PREFERRED EMBODIMENTS

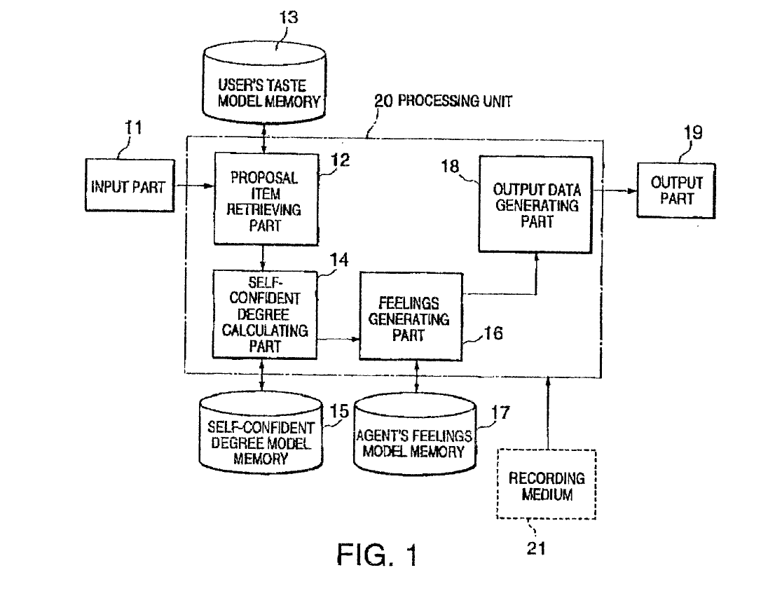

Referring to FIG. 1, the description will proceed to a feeling generation apparatus according to a first embodiment of this invention. The illustrated feeling generation apparatus comprises an input part 11, a proposal item retrieving part 12, a user's taste model memory 13, a self-confident degree calculating part 14, a self-confident degree model memory 15, is feeling generating part 16, an agent's feeling model memory 17, an output data generating part 13, and an output part 19. In addition, the proposal item retrieving part 12, the self-confident degree calculating part 14, the feeling generating part 16, and the output data generating part 18 constitute a processing unit 20. Furthermore, the user's taste model memory 13, the self-confident model memory 15, and the agent's feeling model memory 17 constitute a storage unit.

The input part 11 may be, for example, a keyboard, a voice input device, or the like. The proposal item retrieving part 12 retrieves an item such as a restaurant or a music datum to be proposed for a user. The user's taste model memory 13 stores a user's taste model describing user's tastes. The self-confident degree calculating part 14 calculates a particular self-confidence degree for each proposal item in accordance with a user's taste level. The self-confident model memory 15 stores an agent's self-confident model describing correspondences between user's taste levels for the proposal item and agent's self-confident degrees for proposal. The feeling generating part 16 generates a particular agent's feeling in the manner which will later be described. The agent's feeling model memory 17 stores an agent's feeling model describing correspondences between the agent's self-confident degrees for the proposal item and agent's feelings. The output data generating part 18 generates, in accordance with the generated agent's feeling, a proposal sentence or speech for proposing the item, a CG (computer graphics) animation such as an operation and an expression of the agent and so on. The output part 19 may be, for example a display device or the like.

Referring now to FIGS. 1 through 6, description will be made as regards operation of the feeling generation apparatus illustrated in Fi. 1.

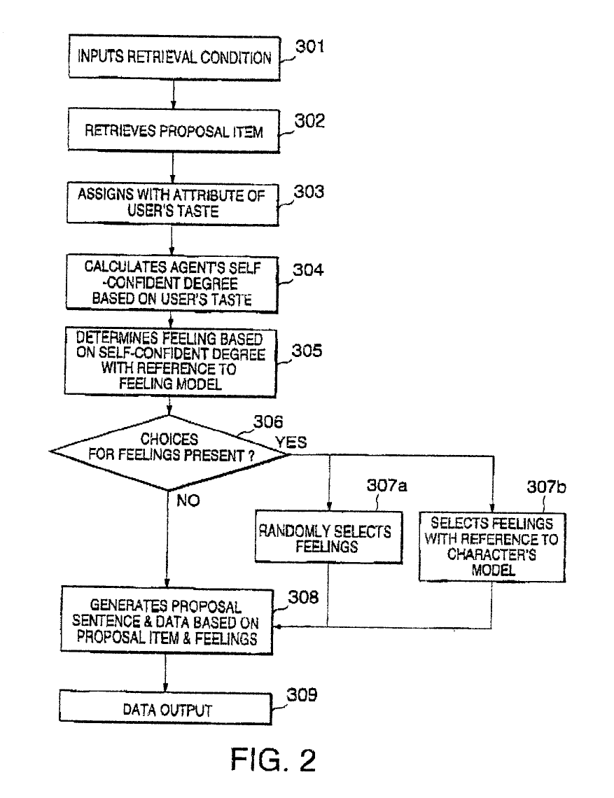

FIG. 2 is a flow chart for showing an example of the operation of the feeling generation apparatus illustrated in FIG. 1.

A user inputs, by using the input part 11, an input condition of an item that desires to propose at a step 301. For example, the user inputs, by using the keyboard or the voice input device, the input condition such as “I want to eat” at the step 301. The step 301 is followed by a step 302 at which the proposal item retrieving part 12 retrieves, in accordance with an inputted retrieval condition or the condition of a meal in this case, categories of a restaurant or store's names as the item which can be proposed to the user. The step 302 proceeds to a step 303 at which the proposal item retrieving part 12 assigns, with reference to the user's taste model stored in the user's taste model memory 13, the user's taste level to each datum of the retrieved restaurant. For instance, the proposal item retrieving part 12 carries out assignment so that Italian food is “a liking”, French food is “a disliking”, and Chinese food is “hard to say which”. The proposal item and the taste data are sent to the self-confident degree calculating part 14. The step 303 is succeeded by a step 304 at which the self-confident degree calculating part 14 calculates, with reference to the agent's self-confident degree model stored in the self-confident degree model memory 15, a particular self-confident degree for the proposal item.

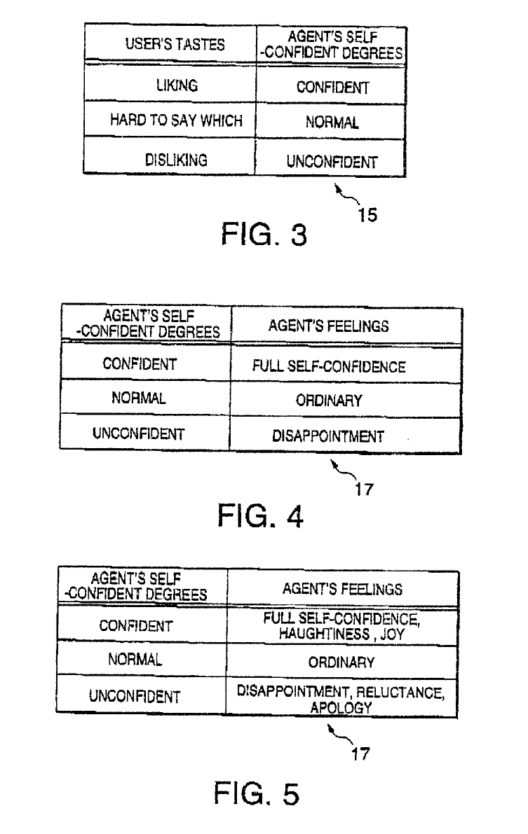

FIG. 3 shows an example of the agent's self-confident degree model stored in the self-confident degree model memory 15. In the example being illustrated in FIG. 3, the user's tastes made to correspond to the agent's self-confident degrees as follows. That is, if the user's taste is the “liking”, the agent's self-confident degree for the proposal is “confident.” If the user's taste is “hard to say which”, the agent's self-confident degree is “normal.” If the user's taste is the “disliking”, the agent's self-confident degree for the proposal is “unconfident.”

In the example being illustrated, inasmuch as the item of Italian food is the “liking”, Italian food is attached to an attribute of “confident”. Likewise, the self-confident degree calculating part 14 attaches attributes of “unconfident” and “normal” to French food and Chinese food, respectively. The self-confident degree calculating part 14 delivers those attributes to the feeling generating part 16. The step 304 is followed by a step 305 at which the feeling generating part 16 determines, with reference to the agent's feeling model stored In the agent's feeling model memory 17, a particular agent's feeling on proposing of the item.

FIG. 4 shows an example of the agent's feeling model stored in the agent's feeling model memory 17. In the example being illustrated in FIG. 4, the agent's self-confident degrees are made to correspond to the agent's feelings as follows. That is, if the agent's self-confident degree is “confident”, its agent's feeling is made to correspond to “full self-confidence.” If the agent's self-confident degree is “normal”, its agent's feeling is made to correspond to “ordinary.” If the agent's self-confident degree is “unconfident”, its agent's feeling is made to correspond to “disappointment.”

The step 305 proceeds to a step 306 at which the feeling generating part 16 determines whether or not there are a plurality of choices for the particular agent's feeling that enables to determine by the agent's feeling model stored in the agent s feeling model memory 17.

If there are no plurality of choices such as the agent's feeling model illustrated in FIG. 4, the feeling generating part 16 determines the particular agent's feeling shown in FIG. 4 and sends it with the proposal item to the output data generating part 18.

FIG. 5 shows another example of the agent's feeling model having a plurality of choices. In the example being illustrated in FIG. 5, the agent's self-confident degrees are made to correspond to the agent's feelings as follows. That is, if the agent's self-confident degree is “confident”, its agent's feeling is made to correspond to “full self-confidence”, “haughtiness”, “joy”, or the like. If the agent's self-confident degree is “normal”, its agent's feeling is made to correspond to “ordinary,” If the agent's self-confident degree is “unconfident”, its agent's feeling is made to correspond to “disappointment”, “reluctantly”, “apology”, or the like.

If there are a plurality of choices for the particular agent's feeling, the feeling generating part 16 selects and determines one of the choices. A selection method for the particular agent's feeling may be a method of randomly selecting one of the choices (step 307a), a method of selecting one of the choices in order, or the like.

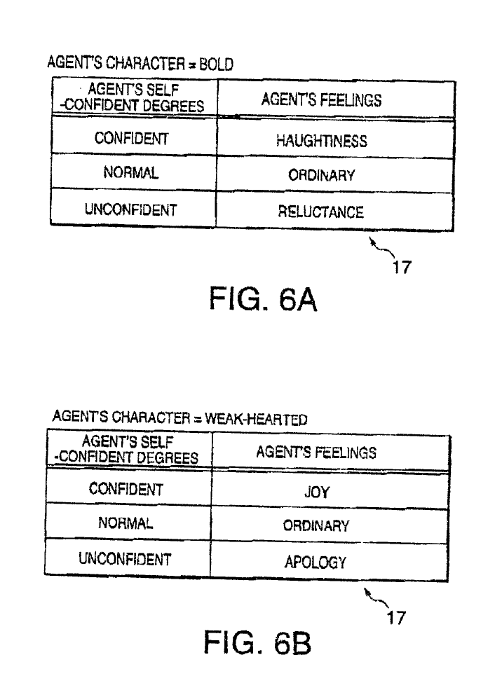

In addition, another selection method for the particular agent's feeling may be a method of determining the particular agent's feeling matched with agent's characters (step 307b). In this event, the agent's feeling model memory 17 stores, as shown in FIGS. 6A and 6B, the agent's feeling model where the agent's feelings are corresponded to the agent's self-confident degrees in accordance with the agent's characters. FIG. 6A shows the agent's feeling model where the agent's character is set to a bold character. FIG. 6B shows the agent's feeling model where the agent's character is set to a weak-hearted character.

It is assumed that the agent's character is set to the hold character as shown in FIG. 6A. In this event, if the agent's self-confident degree is “confident”, its agent's feeling is made to correspond to “haughtiness.” If the agent's self-confident degree is “unconfident”, its agent's feeling is made to correspond to “reluctantly.” It is assumed that the agent's character is set to the weak-hearted character. If the agent's self-confident degree is “confident”, its agent's feeling is made to correspond to “joy.” If the agent's self-confident degree is “unconfident”, its agent's feeling is made to correspond to “apology.” At any rate, the feeling generating part 16 determines the particular agent's feeling on the basis of the agent's character.

On the basis of the particular agent's feeling and the proposal item sent from the feeling generating part 16, the output data generating part 18 generates, in accordance with the particular agent's feeling, the speech for proposing the item, the CG animation such as operation and the expression of the agent and so on (step 308).

For instance, attention will be directed to a case where the item of Italian food is proposed based on the agent's feeling of “full self-confidence.” Under the circumstances, the output data generating part 18 generates a proposal speech such as “I recommend Italian food!” and carries out instruction operation where the CG character instructs this proposal speech with a smiling expression and with jumping up and down, and thereby represents the feeling of the proposal of full self-confidence. In addition, attention will be directed to another case where the item of Chinese food is proposed with the agent's feeling of “ordinary.” Under the circumstances, the output data generating part 18 generates a proposal speech such as “How about Chinese food?” and carries out instruction operation where the CG character instructs this proposal speech with a normal expression, and thereby represents the feeling of the proposal of ordinary. Attention will be directed to still another case where the item of French food is proposed with the agent's feeling of “disappointment.” Under the circumstances, the output data generating part 18 generates a proposal speech such as “Nothing else but French food.” and carries out instruction operation where the CG character instructs this proposal speech with a sadly expression with drooping CG character's shoulders, and thereby represents the feeling of the proposal with not quite recommendation and with disappointment. The generated CG character and voice are displayed by the output part 19 (step 309).

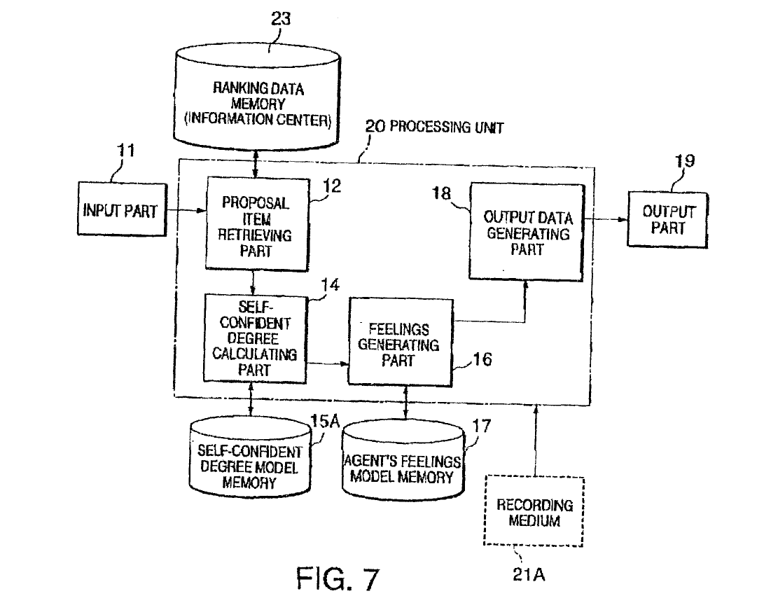

Referring to FIG. 7, the description will proceed to a feeling generation apparatus according to a second embodiment of this invention. The illustrated feeling generation apparatus is similar in structure and operation to the feeling generation apparatus illustrated in FIG. 1 except that the feeling generation apparatus comprises a ranking data memory 23 instead of the user's taste model memory 13 and the agent's self-confident degree model stored in the self-confident degree model memory differs from that illustrated in FIG. 1 as will later become clear. The self-confident degree model memory is therefore depicted at 15A.

The ranking data memory 23 stores ranking data which may be, for example, requested counts in a case of music data, questionnaire collected data in a case of restaurant data. In addition, the self-confident degree model memory 15A stores an agent's self-confident degree model describing correspondences between ranking data and agent's self-confident degrees.

Although the proposal item retrieving part 12 of the feeling generation apparatus illustrated in FIG. 1 assigns, with reference to the user's taste model stored in the user's taste model memory 13, the degree of the user's taste for the retrieved proposal item at the step 303, the proposal item retrieving part 12 of the feeling generation apparatus illustrated in FIG. 7 assigns, with reference to the ranking data stored in the ranking data memory 23, a particular ranking datum for the retrieved proposal item.

The ranking data memory 23 stores, as the ranking data, collected results of the requested counts or the like. For instance, it will be assumed that the ranking data are the music data. In this event, the ranking data memory 23 carries out assignment so that a piece A of a talent B has a rank between first through third ranks from the top or is within top three, a piece C of a talent D has a rank between fourth through tenth ranks from the top or is within top ten, a piece E of a talent F has a rank which is not more than an eleventh rank from the top, and so on.

The proposal item and the retrieved ranking datum are sent from the proposal item retrieving part 12 to the self-confident degree calculating part 14. The self-confident degree calculating part 14 calculates, with reference to the agent's self-confident degree model stored in the self-confident degree model memory 15A, a particular self-confident degree for the proposal item (at the step 304 in FIG. 2).

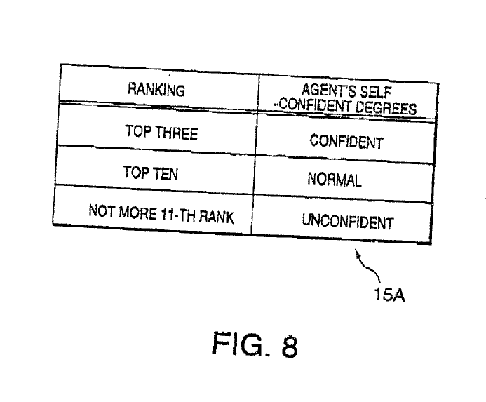

FIG. 8 shows an example of the agent's self-confident degree model stored in the self-confident degree model memory 15A. In the example being illustrated in FIG. 8, the agent's self-confident degree model stored in the self-confident degree model memory 15A describes correspondences between ranking degrees and agent's self-confident degrees as follows. For example, if the ranking is top three or within first through third ranks from the top. the agent's self-confident degree for the proposal is “confident.” If the ranking is top ten or within fourth through tenth ranks from the top, the agent's self-confident degree is “normal.” If the ranking is not more than the eleventh rank from the top, the agent's self-confident degree for the proposal is “unconfident.” In this event, inasmuch as the piece A of the talent B is within “top three”, its self-confident degree is assigned with an attribute of “confident.” Similarly, the self-confident degree calculating part 14 assigns the piece C of the talent D with an attribute of “normal” and assigns the piece E of the talent F with an attribute of “unconfident.” Those attributes are sent from the self-confident degree calculating part 14 to the feeling generating part 16.

In the feeling generation apparatus illustrated in FIG. 7, operation after the step 305 is similar to that in the feeling generation apparatus illustrated in FIG. 1.

In the first and the second embodiments of this invention, the number of classification in the correspondences between the user's tastes and the agent's self-confident degrees, in the correspondences between the ranking data and the agent's self-confident degrees, and in the correspondences between the agent's self-confident degrees and the agent's feelings is exemplified. Therefore, operation is similar if more detailed classification is carried. In addition, other operations are similar If the user's tastes and the agent's self-confident degrees are numerically expressed and a method of designating a range is adopted on corresponding with the feelings.

In the first and the second embodiments of this invention, the feeling generation apparatus generates the agent's feeling for the proposal item by using the attribute called the agent's self-confident degrees attached in accordance with the user's tastes or the popular ranking, It is therefore possible for the feeling generation apparatuses according to the first and the second embodiments of this invention to accompany responses or replies in the system side with the feelings such as self-confidence or enthusiasm, for recommendation.

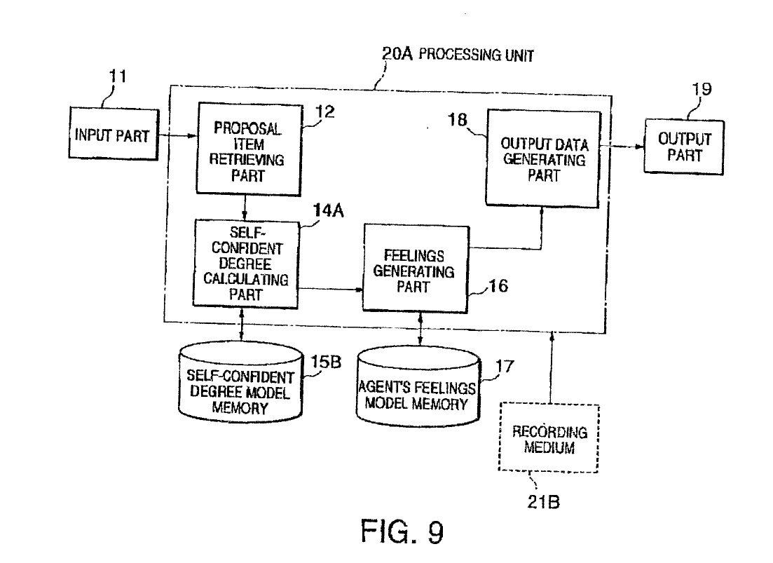

Referring now to FIG. 9, the description will proceed to a feeling generation apparatus according to a third embodiment of this invention. The illustrated feeling generation apparatus is similar in structure and operation to the feeling generation apparatus illustrated in FIG. 1 or FIG. 7 except that the user's taste model memory 13 or the ranking data memory 23 Is omitted, the agent's self-confident degree model stored in the self-confident degree model memory differs from that illustrated in FIG. 1 or FIG. 7 as will later become clear, and a calculating way in the self-confident degree calculating part differs from that illustrated in FIG. 1 or FIG. 7 as will later become clear. The self-confident degree model memory, the self-confident degree calculating part, and the processing unit are therefore depicted at 15B, 14A, and 20A, respectively.

In the manner which will later become clear, the self-confident calculating pail 14A carries out calculation of a particular self-confident degree in accordance with proposal counts delivered from the proposal item retrieving part 12.

In the third embodiment of this invention, when the user inputs a retrieval condition through the input part 11, the proposal item retrieving part 12 retrieves, in accordance with the inputted retrieval condition, an item which can be proposed in the user. It will be assumed that a condition of a meal is inputted as the retrieval condition. In this event, the proposal item retrieving part 12 retrieves, for example, the item of Italian food. The proposal item retrieving part 12 assigns a proposal count of one time to the item of Italian food and sends the item of Italian food and the proposal count to the self-confident degree calculating part 14A. The self-confident degree model memory 15B stores an agent's self-confident degree model describing correspondences between the proposal count and agent's self-confident degrees. The self-confident degree calculating part 14A calculates. in accordance with the agent's self-confident degree model stored in the self-confident degree mode memory 15B, a particular self-confident degree for the proposal item.

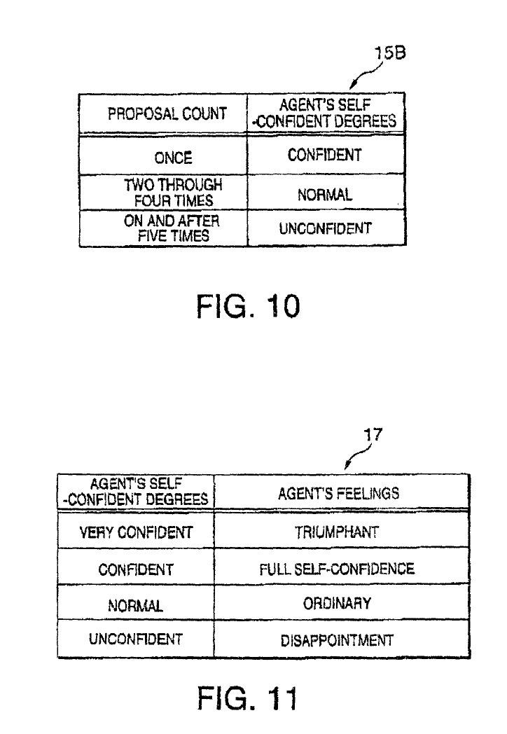

FIG. 10 shows an example of the agent's self-confident degree model stored in the self-confident degree model memory 15B. In the example being illustrated in FIG. 10, the self-confident degree model stored in the self-confident degree model memory 15B describes the correspondences between the proposal count and the self-confident degrees as follows. If the proposal count is one time, the self-confident degree for the proposal item is “confident.” If the proposal count is two through four times, the self-confident degree for the proposal item is “normal.” If the proposal count is on or after five times, the self-confident degree for the proposal item is “unconfident.”

It will be assumed that the proposal count is one time. In this event, inasmuch as its self-confident degree is “confident”, the self-confident degree calculating part 14A assigns an attribute of “confident” to the item of Italian food and sends the item of Italian food and the attribute of “confident” to the feeling generating part 18.

FIG. 11 shows another example of the agent's feeling model stored in the agent's feeling model memory 17. In the example being illustrated in FIG. 11, the agent's self-confident degrees are corresponded to the agent's feelings as follows. That is, if the self-confident degree is “very confident”, its agent's feeling is made to correspond to “triumphant.” If the self-confident degree is “confident”, its agent's feeling is made to correspond to “full self-confidence,” If the self-confident degree is “normal”, its agent's feeling is made to correspond to “ordinary,” If the self-confident degree is “unconfident”, its agent's feeling is made to correspond to “disappointment.”

With reference to the agent's feeling model stored in the agent's feeling model memory 17, the feeling generating part 16 determines, as a particular agent's feeling corresponding to “confident”, “full self-confidence” as shown in FIG. 11. In the agent's feeling model, operation in a case where there are a plurality of choices for the particular agent's feeling is similar to that in a case in the above-mentioned first embodiment. The output data generating part 18 generates, in accordance with the particular agent's feeling of “full self-confidence”, a proposal speech such as “I recommend Italian food” and operation and expression of a CG character.

Now, attention will be directed to a case where this proposal was declined by the user. When the user inputs a condition of “Italian food is disliking” through the input part 11, the proposal item retrieving part 12 retrieves, as a next proposal item which can propose the user, for example, an item of Chinese food. The proposal item retrieving part 12 assigns the item of Chinese food with an attribute of the proposal count of two times and sends the item of Chinese food and the attribute to the self-confident degree calculating part 14A. With reference to the self-confident degree model stored in the self-confident degree model memory 15B, the self-confident model calculating part 14A determines, as the particular self-confident degree for the proposal count of two times, for example, a self-confident degree of “normal.” In this event, with reference to the agent's feeling model stored in the agent's feeling model memory 17, the feeling generating part 16 determines, as the particular agent's feeling, a feeling of “ordinary” as shown in FIG. 11. Subsequently, the output data generating part 18 generates the proposal speech such as “How about Chinese food?” and operation and expression of the CG character corresponding to the feeling of “ordinary.”

It will be assumed that this proposal is also declined by the user. Under the circumstances, the proposal item retrieving part 12 retrieves a different proposal item, assigns it with the attribute of the proposal count incremented by one, and sends those to the self-confident degree calculating part 14A. Inasmuch as the self-confident degree model memory 15B stores the self-confident degree model describing the correspondences between the proposal count and the self-confident degrees, the self-confident degree calculating part 14A determines the particular self-confident degree with reference to the self-confident degree model and subsequently the feeling generating part 16 determines the particular agent's feeling corresponding to the particular self-confident degree with reference to the agent's feeling model stored in the agent's feeling model memory 17.

It will be assumed that the proposal count is on and after five times in a case of the self-confident degree model as illustrated in FIG. 10. In this event, the self-confident degree calculating part 14A determines, as the particular self-confident degree, a self-confident degree of “unconfident” and then the feeling generating part 16 determines, as the particular agent's feeling, a feeling of “disappointment.” It will be assumed that an item of a “light meal” is an item having the proposal count on and after five times. In this event, the output data generating part 18 generates the proposal speech of “Nothing else but light meal, . . . ” with the feeling of disappointment, a sadly expression, and instruction operation where agent's shoulders are dropped.

It will be assumed that the user inputs an affirmative response for this proposed item through the input part 11. In this event, the proposal item retrieval part 12 resets the proposal count for one retrieval condition and prepares to count a proposal count for a next retrieval condition. The proposal count for the next retrieval condition starts one time again and is sent to the self-confident degree calculating part 14A.

For instance, it will be assumed that the user affirms for the proposal of “Nothing else but light meal . . . ” having the proposal count of five times. In this event, the proposal item retrieving part 12 retrieves a candidate of restaurant's names for the input condition of the light meal and assigns the retrieved restaurant's name with an attribute of a proposal count of one time. For example, it will be assumed that an item of “coffee Japanese restaurant” has the proposal count of one time. In this event, the self-confident degree calculating part 14A assigns the item of “coffee Japanese restaurant” with the attribute of “confident” and sends them to the feeling generating part 16. The feeling generating part 16 determines, as the particular agent's feeling, a feeling of “fully self-confident” corresponding to the attribute of “confident” and then the output data generating part 18 carries out a proposal such as “If the light meal is desired, I recommend coffee Japanese restaurant!”

Another operation may be made about a method of determining the proposal count in the proposal item retrieval part 12 and in the self-confident degree calculating part 14A. For instance, it will be assumed that the user inputs an affirmative response for the proposed item through the input part 11 in the manner as described above. In this event, the proposal item retrieving part 12 may decrement the proposal count without resetting the proposal count. Under the circumstances, it will be assumed that the user affirms for the proposal of “I know no more than light meal . . . ” having the proposal count of five times. In this event, the proposal item retrieving part 12 retrieves a candidate of restaurant's names for the input condition of the light meal and assigns the retrieved restaurant's name with an attribute of a proposal count of four times by decrementing the proposal count for the item of the retrieved restaurant by one, For example, it will be assumed that an item of “coffee Japanese restaurant” is retrieved. In this event, the proposal item retrieving part 12 assigns the item of the item of “coffee Japanese restaurant” with the proposal count of four times. The self-confident degree calculating part 14A assigns the item of “coffee Japanese restaurant” with the attribute of the self-confident of “normal” and sends them to the feeling generating part 16. The feeling generating part 16 determines, as the particular agent's feeling, a feeling of “ordinary” corresponding to the attribute of “normal” and then the output data generating part 18 carries out a proposal such as “if you want the light meal, how about going to Japanese restaurant?”

In addition, in the self-confident degree model stored in the self-confident degree model memory 15B the correspondences between the proposal count and the self-confident degrees may be altered in accordance with the agent's character.

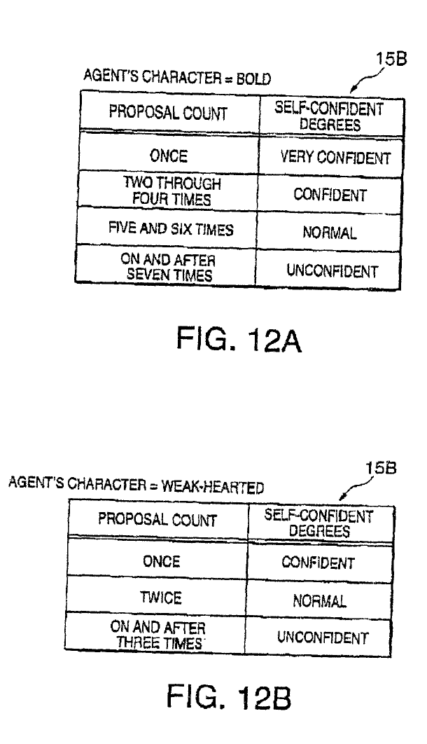

FIG. 12A shows the agent's self-confident degree model in a case where the agent's character is set to a bold character. When the agent's character is set to the bold character, the self-confident degree model is set to a model so that the self-confident degree is not lowered too much although the proposal count increases. In this event, while negation for the proposal items is repeated by the user and different items are successively proposed, the self-confident degree calculated by the self-confident degree calculating part 14A is not lowered to much and the feeling such as “triumphant” or “fully self-confident” continues for a long time as the particular agent's feeling generated by the feeling generating part 16.

As shown in FIG. 12A, the self-confident degree is set to “very confident” if the proposal count is one time. If the proposal count is any one of two through four times, the self-confident degree is set to “confident.” If the proposal count is any one of five and six times, the self-confident degree is set to “normal.” If the proposal count is on and after seven times, the self-confident degree is set to “unconfident.”

More specifically, inasmuch as the proposal item having the proposal count of one time is assigned with the self-confident degree of “very confident” as shown in FIG. 12A, the proposal with the feeling of “triumphant” is carried out as shown in FIG. 11. When the proposal item of one time is declined and a proposal of two times is carried out, the proposal with the feeling of “fully self-confident” is carried out because the proposal item having the proposal count of two times is assigned with the self-confident degree of “confident.” Until the proposal item having the proposal count of four times caused by negation, the proposal with the fully self-confident feeling is carried out.

FIG. 12B shows the agent's self-confident degree model in a case where the agent's character is set to a weak-hearted character. When the agent's character is set to the weak-hearted character, the self-confident degree model is set to a model so that the agent immediately lacks self-confidence when the proposal is declined by the user and the self-confident degree is not so strong although the proposal count is one time. In this event, the self-confident degree calculated by the self-confident degree calculating part 14A is not so high from the proposal count of one time and the self-confident degree is lower whenever negation for the proposal item is carried out by the user. In addition, the particular agent's feeling generated by the feeling generating part 16 immediately changes from “full self-confidence” through “ordinary” to “disappointment.”

As shown in FIG. 12B, the self-confident degree is set to “confident” if the proposal count is once (one time). If the proposal count is two times, the self-confident degree is set to “normal.” If the proposal count is on and after three times, the self-confident degree is set to “unconfident.”

More specifically, inasmuch as the proposal item having the proposal count of one time is assigned with the self-confident degree of “confident” as shown in FIG. 12B, the proposal with the feeling of “full self-confidence” is carried out as shown in FIG. 11. Compared with the bold agent having the feeling of “triumphant” for the proposal item having the proposal count of one time, the weak-hearted agent has slightly weaker feeling for the proposal item having the proposal count of one time and it results in representing the agent's character. When the proposal item of one time is declined and a proposal of twice (two times) is carried out, the proposal with the feeling of “ordinary” is carried out because the proposal item having the proposal count of two times is assigned with the self-confident degree of “normal.” When this proposal is declined and a proposal of three times is carried out, the proposal with the feeling of “disappointment” is carried out because the proposal item having the proposal count of three times is assigned with the self-confident degree of “unconfident.”

In addition, the self-confident degree model stored in the self-confident degree model memory 15B may describe correspondences between a combination of user's tastes and proposal count and self-confident degrees by combining the first embodiment with the third embodiment and the self-confident degree calculating part 14A may determine the particular self-confident degree with reference to this self-confident degree model.

In the third embodiment of this invention, the number of classification in the correspondences between the proposal count and the agent's self-confident degrees and in the correspondences between the self-confident degrees and the agent's feelings is exemplified. Therefore, operation is similar if more detailed classification is carried. In addition, other operations are similar if the self-confident degrees are numerically expressed and a method of designating a range is adopted on corresponding with the agent's feelings.

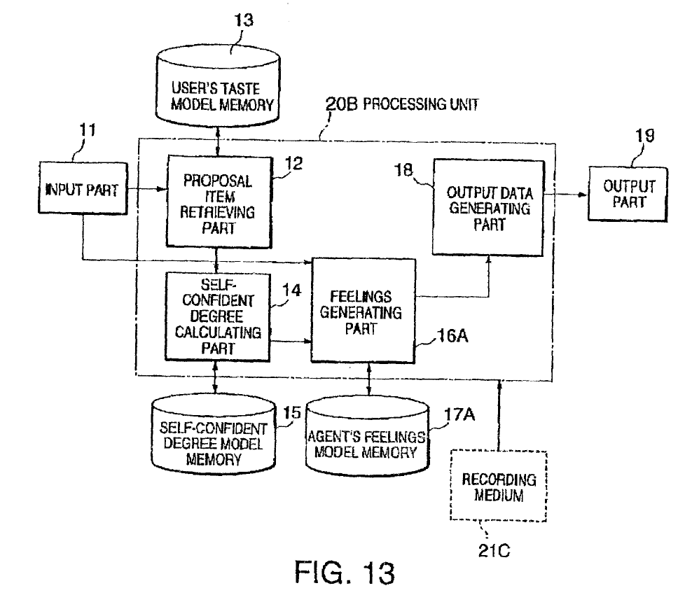

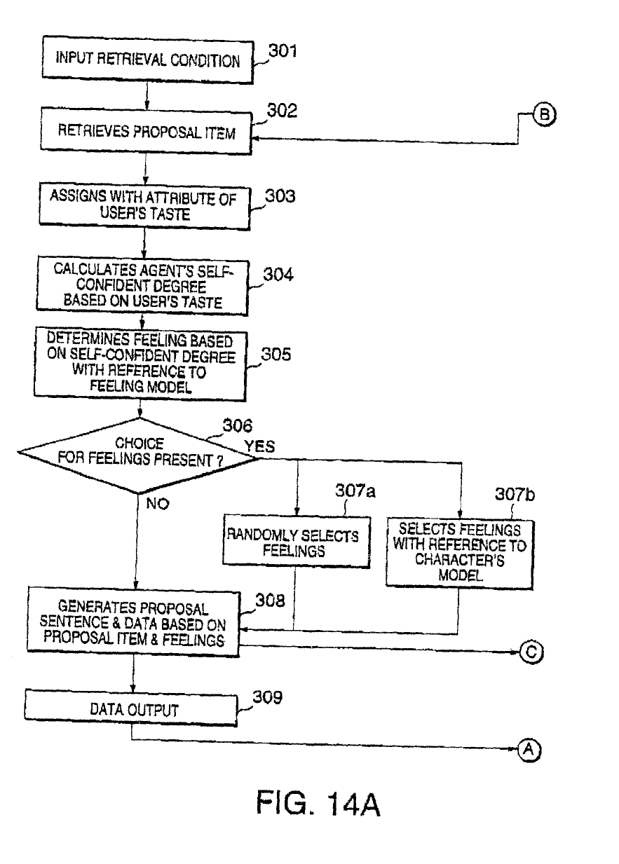

Referring to FIG. 13, the description will proceed to a feeling generation apparatus according to a fourth embodiment of this invention. The illustrated feeling generation apparatus is similar in structure and operation to the feeling generation apparatus illustrated in FIG. 1 except that operation in the feeling generating part differs from that illustrated in FIG. 1 and the agent's feeling model stored in the agent's feeling model memory differs from that illustrated in FIG. 1 as will later become clear. The feeling generating part, the agent's feeling model memory, and the processing unit are therefore depicted at 16A, 17A, and 20B, respectively.

The feeling generating part 16A is supplied not only with the agent's particular self-confident degree for the proposal item from the self-confident degree calculating part 14 but also with a user's responses from the input part 11.

In the fourth embodiment, when the user carries out a response or reply such as affirmation or negation for the proposed item with the feeling corresponding to the agent's self-confident degree, this response is used as a second input to carry out feeling generation. With reference to two attributes, namely, the particular self-confident degree for the proposed item sent from the self-confident degree calculating part 14 and the user's response sent from the input part 11. the feeling generating part 16A generates the particular agent's feeling.

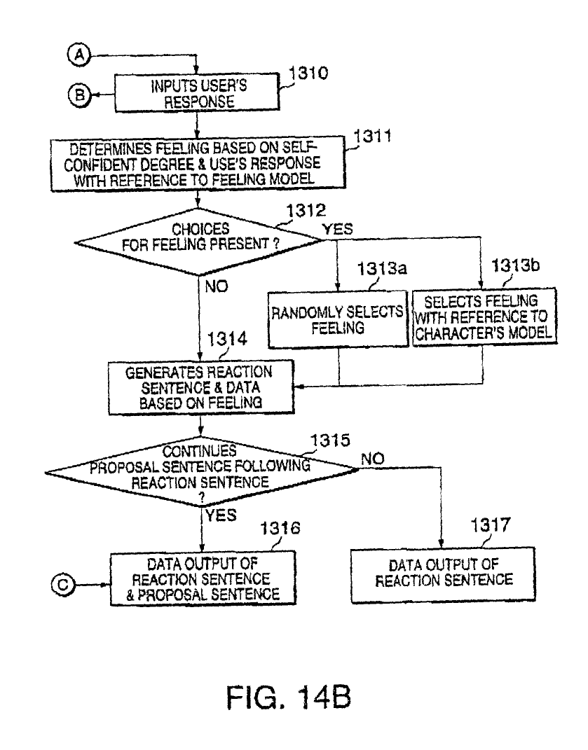

Referring now to FIGS. 14A and 14B in addition to FIG. 13, description will be made as regards operation of the feeling generation apparatus illustrated in FIG. 13. Operation from the step 301 to the step 309 in FIG. 14A is similar to those in FIG. 2. For instant, it will be assumed that the user inputs a condition such as “I want to eat” through the input part 11. In this event, the self-confident degree calculating part 14 calculates the agent's particular self-confident degree on the basis of the correspondence between the degrees of the user's taste and the self-confident degree. Subsequently, the feeling generating part 16A determines the particular agent's feeling on the basis of the correspondence between the particular self-confident degree and the agent's feeling. The output data generating part 18 generates the proposal speech of “I recommend Italian food. Would you like it?” with the feeling of “full self-confidence” and generates operation and expression. The output part 19 outputs the proposal speech, the operation and the expression.

Now, attention will be directed to a case where the user inputs the response for the proposed item through the input part 11. The user carries out, as a user's response, an affirmative response or a negative response for the proposed item of “Italian food” and the user's response is inputted from the input part 11 at a step 1310. The user's response is sent to the proposal item retrieving part 12 and a retrieval in conformity with a condition (the user's response) is newly carried out at a step 1311. Simultaneously, the user's response is sent to the feeling generating part 16A to generate the particular agent's feeling for the user's response.

Description will be made as regards operation of the feeling generating part 16A. The feeling generating part 16A determines the particular agent's feeling with reference to the agent's feeling model stored in the agent's feeling model memory 17A at the step 1311. Stored in the agent's feeling model memory 17A, the agent's feeling model describes the correspondences between the agent's feelings and two attributes consisting of the agent's self-confident degrees for the proposed item and the user's responses.

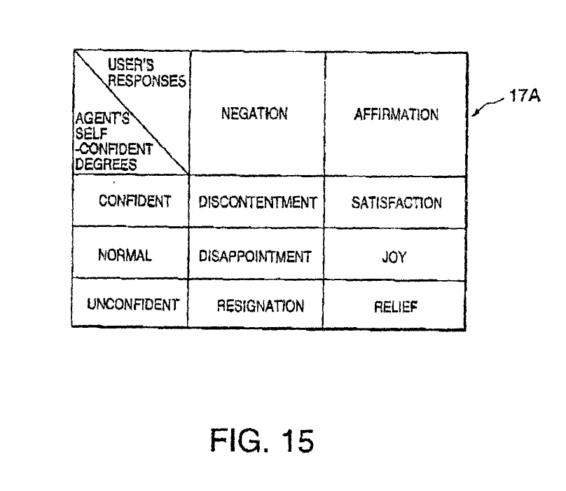

FIG. 15 shows an example of the agent's feeling model stored in the agent's feeling model memory 17A. In the agent's feeling model as shown in FIG. 15, the agent's feeling corresponds to a feeling of “discontentment” when the user's response sent from the input part 11 is “negation” for the proposed item with the agent's self-confident degree of “confident.” When the user's response is “affirmation” for the proposed item with the agent's self-confident degree of “confident”, the agent's feeling corresponds to a feeling of “satisfaction,” When the user's response is “negation” for the proposed item with the self-confident degree of “normal”, the agent's feeling corresponds to a feeling of “disappointment.” When the user's response is “affirmation” for the proposed item with the self-confident degree of “normal”, the agent's feeling corresponds to a feeling of “joy.” When the user's response is “negation” for the proposed item with the self-confident degree of “unconfident”, the agent's feeling corresponds to a feeling of “resignation.” When the user's response is “affirmation” for the proposed item with the self-confident degree of “unconfident”, the agent's feeling corresponds to a feeling of “relief.”

The step 1311 is followed by a step 1312 at which the feeling generating part 16A determines whether or not there are a plurality of choices for particular agent's feeling which enables to determine by the agent's feeling model stored in the agent's feeling model memory 17A. When there is no choice as shown in FIG. 15, the feeling generating part 16A determines the particular agent's feeling in accordance with a table illustrated in FIG. 15 and sends the particular agent's feeling to the output data generating part 18. Responsive to the particular agent's feeling sent from the feeling generating part 16A, the output data generating part 18 generates a speech, an operation, and an expression for reacting to the user's response.

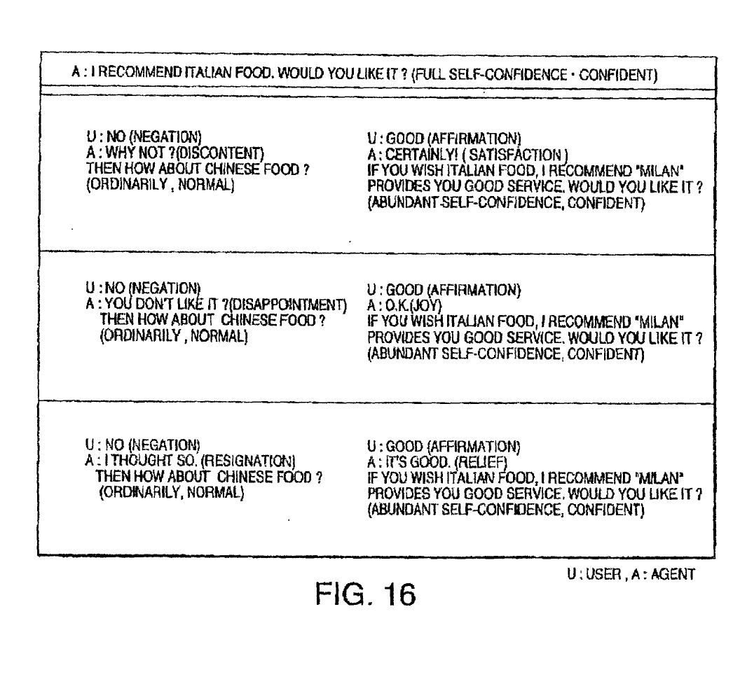

FIG. 16 shows an example of conversation between the agent and the user. It will be assumed that the user denies such as “No” or the like for the proposal item of “I recommend Italian food. Would you like it?” with the feeling of “full self-confidence” or the proposal item with “confident.” In this event, the feeling generating part 16A generates, with reference to the agent's feeling model stored in the agent's feeling model memory 17A, the feeling of “discontentment” as the particular agent's feeling. Responsive to the feeling of “discontentment”, the output data generating part 18 generates, as a reaction sentence corresponding to “discontentment”, a speech such as “Why not?” and generates an agent's reaction indicative of discontentment for the user's response such as an expression of frowning with putting the corners of his mouth down and an operation of laying his hands on his waist.

Similarly, it will be assumed that the user affirms such as “Good” for the proposal item with “confident.” In this event, the feeling generating part 16A generates, with reference to the agent's feeling model stored in the agent's feeling model memory 17A, the feeling of “satisfaction” as the particular agent's feeling. Responsive to the feeling of “satisfaction”, the output data generating part 18 generates, as a reaction sentence corresponding to “satisfaction”, a speech such as “Certainly!” and generates an agent's reaction indicative of satisfaction for the user's response such as an expression of winking with closing one eye and an operation of throwing out this chest.

The step 1314 proceeds to a step 1315 at which the output data generating part 18 determines whether or not a proposal sentence is generated following the reaction sentence. When a next item is retrieved by the proposal item retrieving part 12, the step 1315 is succeeded by a step 1316 at which the output data generating part 18 generates the proposal item following the reaction sentence such as “Why not?” When the next item is not retrieved by the proposal item retrieving part 12, the step 1315 is followed by a step 1317 at which the output part 19 outputs only the reaction sentence.

Now, the description will be made as regards generation of the proposal sentence following the reaction sentence. When the user makes the affirmative response or the negative response for the proposed item such as “Italian food” at the step 1310, the proposal item retrieving part 12 carries out, in response to the user's response, the retrieval in conformity with the condition at the step 302. For instance, it will be assumed that the user makes the negative response such as “No” for the proposal of “Italian food.” In this event, the proposal item retrieving part 12 retrieves a category of different restaurant except for Italian food The proposal item retrieving part 12 refers to the user's taste model stored in the user's taste model memory 13, determines a proposal item of the category such as “Chinese food=hard to say which” matched with a next user's taste following Italian food, and sends the determined proposal item to the self-confident degree calculating part 14. The self-confident degree calculating part 14 calculates the agent's particular self-confident degree on the basis of the degree of the user's taste. The feeling generating part 16A determines the particular agent's feeling on the basis of the agent's particular self-confident degree. The output data generating part 18 generates the proposal speech of “How about Chinese food?” for proposing the item of Chinese food with the feeling of “ordinary” or the like and generates operation and expression of the CG character therefor.

The conversation between the user and the agent flows as follows. More specifically, when the user inputs “I want to eat.”, the agent proposes “I recommend Italian food. Would you like it?” with the feeling of “fully self-confident.” When the user denies “No”, the agent entertains the feeling of “discontentment” because a confident one is declined and replies a reaction of “Why not?” Subsequently, the agent proposes the speech of “Then how about Chinese food?” with the feeling of “ordinary” because the particular self-confident degree is “normal.” A new agent's feeling is generated caused by whether the next user's response is affirmative or negative for the proposal item of “Chinese food” with the agent's self-confident degree of “normal.”

Now, description will be made as regards a case where there are a plurality of choices for the particular agent's feeling enable to determine in the agent's feeling model stored in the agent's feeling model memory 17A at the step 1312 of FIG. 14.

A selection method for the particular agent's feeling may be a method of randomly selecting the particular agent's feeling (step 1313a) or a method of selecting the particular agent's feeling in order.

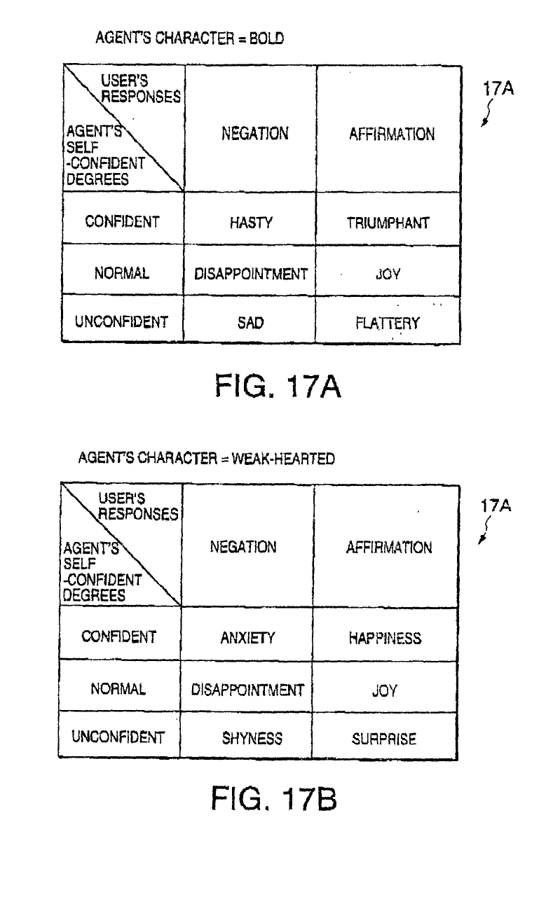

Another selection method for the particular agent's feeling may be a method of determining the particular agent's feeling matched with agent's characters (step 1313b). In this event, the agent's feeling model memory 17A stores, as shown in FIGS. 17A and 17B, the agent's feeling model where the agent's feelings are corresponded to the agent's self-confident degrees in accordance with the agent's characters, FIG. 17A shows the agent's feeling model where the agent's character is set to a bold character. FIG. 17B shows the agent's feeling model where the agent's character is set to a weak-hearted character.

It will be assumed that the agent's character is set to the bold character as shown in FIG. 17A. In this event, the agent's feeling model is set so that the agent entertains a feeling of “hasty” as the agent's feeling when the proposal item having the self-confident degree of “confident” is declined while the agent entertains a feeling of “triumphant” as the agent's feeling when the item having the self-confident degree of “confident” is affirmed. In addition, the agent's feeling model is set so that the agent entertains a feeling of “disappointment” as the agent's feeling when the proposal item having the self-confident degree of “normal” is declined while the agent entertains a feeling of “joy” as the agent's feeling when the item having the self-confident degree of “normal” is affirmed. Furthermore, the agent's feeling model is set so that the agent entertains a feeling of “sad” as the agent's feeling when the proposal item having the self-confident degree of “unconfident” is declined while the agent entertains a feeling of “flattery” as the agent's feeling when the item having the self-confident degree of “unconfident” is affirmed.

It will be assumed that the agent's character is set to the weak-hearted character as shown in FIG. 17B. In this event, the agent's feeling model is set so that the agent entertains a feeling of “anxiety” as the agent's feeling when the proposal item having the self-confident degree of “confident” is declined while the agent entertains a feeling of “happiness” as the agent's feeling when the item having the self-confident degree of “confident” is affirmed. In addition, the agent's feeling model is set so that the agent entertains a feeling of “disappointment” as the agent's feeling when the proposal item having the self-confident degree of “normal” is declined while the agent entertains a feeling of “joy” as the agent's feeling when the item having the self-confident degree of “normal” is affirmed. Furthermore, the agent's feeling model is set so that the agent entertains a feeling of “shyness” as the agent's feeling when the proposal item having the self-confident degree of “unconfident” is declined while the agent entertains a feeling of “surprise” as the agent's feeling when the item having the self-confident degree of “unconfident” is affirmed.

In the fourth embodiment of this invention, the particular agent's feeling corresponding to the generated reaction sentence is determined on the basis of a general attribute such as the agent's self-confident degree for the proposal item and of the user's response such as affirmation or negation As a result, such agent's feelings can be commonly used in a plurality of applications for presenting various data indicative of proposal contents such as music data, stores, hotels, schedule data, and so on. Accordingly, it is possible to use the reaction sentences with the feelings in the plurality of applications in common.

While this invention has thus far been described in conjunction with preferred embodiments thereof, it will now be readily possible for those skilled in the art to put this invention into various other manners. For example, computer programs realizing each part in the processing units 20, 20A, and 20B in the above-mentioned embodiments may be recorded or stored in recording media 21, 21A, 21B, and 21C depicted at broken lines in FIGS. 1, 7, 9, and 13, respectively. In addition, data stored in each memory 13, 15, 15A, 17, 17A, or 23 in the above-mentioned embodiments may be recorded or stored in a recording medium. The “recording medium” means a computer readable recording medium for recording computer programs or data and, in particularly, includes a CD-ROM, a magnetic disk such as a flexible disk, a semiconductor memory, or the like. The recording medium may be a magnetic tape for recording programs or data and may be distributed through a communication line.

What is claimed is:

1. A method of accompanying a proposal item presented by a computer with a feeling, said method comprising the step of generating an agent's feeling for said proposal item by using an attribute called an agent's self-confident degree attached according to a user's taste.

2. A method of generating an agent's feeling for a proposal item presented by a computer, said method comprising the step of generating the agent's feeling for said proposal item by using an attribute called an agent's self-confident degree.

3. A method as claimed in claim 2, wherein said agent's self-confident degree is attached according to a user's taste.

4. A method as claimed in claim 2, wherein said agent's self-confident degree is attached according to popular ranking.

5. A method of proposing, by using a computer, an item matched with an input condition of a user, said method comprising the steps of:
calculating, with reference of user's taste, an attribute called an agent's self-confident degree for proposal;
generating an agent's feeling in accordance with the calculated agent's self-confident degree; and
proposing said item in accordance with the generated agent's feeling.

6. A method of proposing, by using a computer, an item matched with an input condition of a user, said method comprising the steps of:
retrieving said item;
assigning, with reference to a user's taste model, a particular taste level to the retrieved item;
calculating, with reference to an agent's self-confident degree model describing correspondences between taste levels and agent's self-confident degrees, an agent's self-confident degree for each proposal item;
determining, with reference to an agent's feeling model, an agent's feeling in accordance with the calculated agent's self-confident degree; and
generating, in accordance with the determined agent's feeling, a proposal sentence for proposing said item and data for an operation and an expression of a computer graphics (CG) character.

7. A feeling generation apparatus for accompanying a reaction and an information proposal of a computer with an agent's feeling, said feeling generation apparatus comprising:
a user's taste model memory for storing a user's taste model describing user's tastes for a user;
a proposal item retrieving part for retrieving a proposal item matched with an input condition of said user, said proposal item retrieving part assigning, with reference to said user's taste model, a taste level to said proposal item;
a self-confident degree model memory for storing an agent's self-confident degree model describing correspondences between taste's levels for said proposal item and agent's self-confident degrees for proposal;
a self-confident degree calculating part for determining, with reference to said agent's self-confident degree model, an agent's self-confident degree for said proposal item;
an agent's feeling model memory for storing an agent's feeling model describing correspondences between said agent's self-confident degrees and agent's feelings;
a feeling generating part for determining, with reference to said agent's feeling model, the agent's feeling for said determined agent's self-confident degree; and
an output data generating part for generating, in accordance with said determined agent feeling, a proposal sentence for proposing the proposal item and data for an operation and an expression of a computer graphics (CG) character.

8. A feeling generation apparatus for accompanying a reaction and an information proposal of a computer with an agent's feeling, said feeling generation apparatus comprising:
a ranking data memory for storing popular ranking data;
a proposal item retrieving part for retrieving a proposal item matched with an input condition of a user, said proposal item retrieving part assigning, with reference to said popular ranking data, a popular ranking to said proposal item;
a self-confident degree model memory for storing an agent's self-confident degree model describing correspondences between popular ranks for said proposal item and agent's self-confident degrees for proposal;
a self-confident degree calculating part for determining, with reference to said agent's self-confident degree model, an agent's self-confident degree for said proposal item;
an agent's feeling model memory for storing an agent's feeling model describing correspondences between said agent's self-confident degrees and agent's feelings;
a feeling generating part for determining, with reference to said agent's feeling model, the agent's feeling for said determined agent's self-confident degree; and
an output data generating part for generating, in accordance with said determined agent's feeling, a proposal sentence for proposing the proposal item and data for an operation and an expression of a computer graphics (CG) character.

9. A feeling generation apparatus for accompanying a reaction and an information proposal of a computer with an agent's feeling, said feeling generation apparatus comprising:
a proposal item retrieving part for retrieving a proposal item matched with an input condition of a user to produce the proposal item;
a self-confident degree model memory for storing an agent's self-confident degree model describing correspondences between a proposal count for said proposal item and agent's self-confident degrees for proposal;
a self-confident degree calculating part for determining, with reference to said agent's self-confident degree model, an agent's self-confident degree in accordance with the proposal count for said proposal item sent from said proposal item retrieving part;
an agent's feeling model memory for storing an agent's feeling model describing correspondences between said agent's self-confident degrees and agent's feelings;
a feeling generating part for determining, with reference to said agent's feeling model, the agent's feeling for said determined agent s self-confident degree; and
an output data generating part for generating, in accordance with said determined agent's feeling, a proposal sentence for proposing the proposal item and data for an operation and an expression of a computer graphics (CG) character.

10. A feeling generation apparatus as claimed in claim 9, wherein said self-confident degree model memory stores said agent's self-confident degree model describing the correspondences between said proposal count for said proposal item and said agent's self-confident degrees which differ in accordance with an agent's character; and
said self-confident degree calculating part calculating the agent's self-confident degree corresponding to said proposal count with adding the agent's character.

11. A feeling generation apparatus for accompanying a reaction and an information proposal of a computer with an agent's feeling, said feeling generation apparatus comprising:
a user's taste model memory for storing a user's taste model describing user's tastes for a user;
a proposal item retrieving part for retrieving a proposal item matched with an input condition of said user, said proposal item retrieving part assigning, with reference to said user's taste model, a taste level to said proposal item;
a self-confident degree model memory for storing an agent's self-confident degree mode describing correspondences between taste's levels for said proposal item and agent's self-confident degrees for proposal;
a self-confident degree calculating part for determining, with reference to said agent's self-confident degree model, an agent's self-confident degree for said proposal item;
an agent's feeling model memory for storing an agent's feeling model describing correspondences among said agent's self-confident degrees, user's responses, and agent's feelings;
a feeling generating part for determining, with reference to said agent's feeling model, the agent's feeling on the basis of two attributes of the determined agent's self-confident degree and a user's response inputted from an input part; and
an output data generating part for generating, in accordance with said determined agent feeling, a proposal sentence for proposing the proposal item and data for an operation and an expression of a computer graphics (CG) character.

12. A feeling generation apparatus as claimed in claim 11, wherein said agent's feeling model memory stores the agent's feeling model describing a model where different feelings are selected for each agent's character in the agent's feeling determined by the determined agent's self-confident degree and the user's response; and
said feeling generating part generating the agent's feeling which differs from each agent's character.

13. A method for reacting, in a computer, to a user's response for a proposal sentence, said method comprising the steps of:
inputting said user's response;
determining, with reference to an agent's feeling model, an agent's feeling on the basis of said user's response and an agent's self-confident degree for an item proposed on proposing said proposal sentence; and
generating an agent's reaction sentence with said determined agent feeling and data for an operation and an expression of a computer graphics (CG) character.

14. A computer program embodied on a computer readable medium for accompanying a reaction and an information proposal of a computer with an agent's feeling, said computer program comprising:
a proposal item retrieving code segment for retrieving a proposal item matched with an input condition of a user, said proposal item retrieving code segment assigning, with reference to a user's taste model memory for storing a user's taste model describing user's tastes for said user, a taste level to said proposal item;
a self-confident degree calculating code segment for determining, with reference to a self-confident degree model memory for storing an agent's self-confident degree model describing correspondences between taste's levels for said proposal item and agent's self-confident degrees for proposal, an agent's self-confident degree for said proposal item;
a feeling generating code segment for determining, with reference to an agent's feeling model memory for storing an agent's feeling model describing correspondences between said agent's self-confident degrees and agent's feelings, the agent's feeling for said determined agent's self-confident degree; and
an output data generating code segment for generating, in accordance with said determined agent feeling, a proposal sentence for proposing the proposal item and data for an operation and an expression of a computer graphics (CG) character.

15. A computer program embodied on a computer readable medium for accompanying a reaction and an information proposal of a computer with an agent's feeling, said computer program comprising:
a proposal item retrieving code segment for retrieving a proposal item matched with an input condition of a user, said proposal item retrieving code segment assigning, with reference to a ranking data memory for storing popular ranking data, a popular ranking to said proposal item;
a self-confident degree calculating code segment for determining, with reference to a self-confident degree model memory for storing an agent's self-confident degree model describing correspondences between popular ranks for said proposal item and agent's self-confident degrees for proposal, an agent's self-confident degree for said proposal item;
a feeling generating code segment for determining, with reference to an agent's feeling model memory for storing an agent's feeling model describing correspondences between said agent's self-confident degrees and agent's feelings, the agent's feeling for said determined agent's self-confident degree; and
an output data generating code segment for generating, in accordance with said determined agent's feeling, a proposal sentence for proposing the proposal item and data for an operation and an expression of a computer graphics (CG) character.

16. A computer program embodied on a computer readable medium for accompanying a reaction and an information proposal of a computer with an agent's feeling, said computer program comprising:
a proposal item retrieving code segment for retrieving a proposal item matched with an input condition of a user to produce the proposal item;
a self-confident degree calculating code segment for determining, with reference to a self-confident degree model memory for storing an agent's self-confident degree model describing correspondences between a proposal count for said proposal item and agent's self-confident degrees for proposal, an agent's self-confident degree in accordance with the proposal count for said proposal item sent from said proposal item retrieving part;
a feeling generating code segment for determining, with reference to an agent's feeling model memory for storing an agent's feeling model describing correspondences between said agent's self-confident degrees and agent's feelings, the agent's feeling for said determined agent's self-confident degree; and
an output data generating code segment for generating, in accordance with said determined agent's feeling, a proposal sentence for proposing the proposal item and data for an operation and an expression of a computer graphics (CG) character.

17. A computer program as claimed in claim 16, wherein said self-confident degree model memory stores said agent's self-confident degree model describing the correspondences between said proposal count for said proposal item and said agent's self-confident degrees which differ in accordance with an agent's character, said self-confident degree calculating code segment calculating the agent's self-confident degree corresponding to said proposal count with adding the agent's character.

18. A computer program embodied on a computer readable medium for accompanying a reaction and an information proposal of a computer with an agent's feeling, said computer program comprising:
a proposal item retrieving code segment for retrieving a proposal item matched with an input condition of a user, said proposal item retrieving code segment assigning, with reference to a user's taste model memory for storing a user's taste model describing user's tastes for said user, a taste level to said proposal item;
a self-confident degree calculating code segment for determining, with reference to a self-confident degree model memory for storing an agent's self-confident degree model describing correspondences between taste's levels for said proposal item and agent's self-confident degrees for proposal, an agent's self-confident degree for said proposal item;
a feeling generating code segment for determining, with reference to an agent's feeling model memory for storing an agent's feeling model describing correspondences among said agent's self-confident degrees, user's responses, and agent's feelings, the agent's feeling on the basis of two attributes of the determined agent's self-confident degree and a user's response inputted from an input part; and
an output data generating code segment for generating, in accordance with said determined agent feeling, a proposal sentence for proposing the proposal item and data for an operation and an expression of a computer graphics (CG) character.

19. A computer program as claimed in claim 18, wherein said agent's feeling model memory stores the agent's feeling model describing a model where different feelings are selected for each agent's character in the agent's feeling determined by the determined agent's self-confident degree and the user's response, said feeling generating code segment generating the agent's feeling which differs from each agent's character.

20. A computer readable medium for recording agent's feeling data corresponding to proposal items, said computer readable medium comprising:
a user's taste model memorizing section for recording a user's taste model describing correspondences between said proposal items and user's taste levels;
a self-confident degree model memorizing section for recording an agent's self-confident degree model describing correspondences between said user's taste levels and agent's self-confident degrees for proposal; and
an agent's feeling model memorizing section for recording an agent's feeling model describing correspondences between said agent's self-confident degrees and said agent's feeling data.

21. A computer readable medium for recording agent's feeling data corresponding to proposal items, said computer readable medium comprising:
a ranking data memorizing section for recording popular ranking data for said proposal items;
a self-confident degree model memorizing section for recording an agent's self-confident degree model describing correspondences between popular ranks for said proposal item and agent's self-confident degrees for proposal; and
an agent's feeling model memorizing section for recording an agent's feeling model describing correspondences between said agent's self-confident degrees and said agent's feeling data.

22. A computer readable medium for recording agent's feeling data corresponding to proposal items, said computer readable medium comprising:
a self-confident degree model memorizing section for recording an agent's self-confident degree model describing correspondences between a proposal count for said proposal items and agent's self-confident degrees for proposal; and
an agent's feeling model memorizing section for recording an agent's feeling model describing correspondences between said agent's self-confident degrees and said agent's feeling data.

23. A computer readable medium for recording agent's feeling data corresponding to user's responses for proposal items, said computer readable medium comprising:
a user's taste model memorizing section for recording a user's taste model describing user's taste levels and said proposal items;
a self-confident degree model memorizing section for recording an agent's self-confident degree model describing correspondences between said user's taste levels and agent's self-confident degrees for proposal; and
an agent's feeling model memorizing section for recording an agent's feeling model describing correspondences two attributes of said agent's self-confident degrees and said user's responses and said agent's feeling data.

24. A computer program embodied on a computer readable medium for proposing, by using a computer, an item matched with an input condition of a user, said computer program comprising:
a code segment that calculates, with reference of user's taste, an attribute called an agent's self-confident degree for proposal;
a code segment that generates an agent's feeling in accordance with the calculated agent's self-confident degree; and
a code segment that proposes said item in accordance with the generated agent's feeling.

25. A computer program embodied on a computer readable medium for proposing, by using a computer, an item matched with an input condition of a user, said computer program comprising:
a code segment that retrieves said item;
a code segment that assigns, with reference to a user's taste model, a particular taste level to the retrieved item;
a code segment that calculates, with reference to an agent's self-confident degree model describing correspondences between taste levels and agent's self-confident degrees, an agent's self-confident degree for each proposal item;
a code segment that determines, with reference to an agent's feeling model, an agent's feeling in accordance with the calculated agent's self-confident degree; and
a code segment that generates, in accordance with the determined agent's feeling, a proposal sentence for proposing said item and data for an operation and an expression of a computer graphics (CG) character.

26. A computer program embodied on a computer readable medium for reacting, in a computer, to a user's response for a proposal sentence, said computer program comprising:
a code segment that inputs said user's response;
a code segment that determines, with reference to an agent's feeling model, an agent's feeling on the basis of said user's response and an agent's self-confident degree for an item proposed on proposing said proposal sentence; and
a code segment that generates an agent's reaction sentence with said determined agent feeling and data for an operation and an expression of a computer graphics (CG) character.
